(19) United States
(12) Patent Application Publication
(10) Pub. No.: US 2002/0010722 A1
(43) Pub. Date: Jan. 24, 2002

(54) Information processing apparatus, image processing apparatus, print order processing method of information processing apparatus, and print request processing method of image processing apparatus

(76) Inventor: Nobutoshi Takayama, Kanagawa (JP)

Correspondence Address: MORGAN & FINNEGAN, L.L.P., 345 PARK AVENUE, NEW YORK, NY, 10154, US

(21) Appl. No.: 09/907,999

(22) Filed: Jul. 18, 2001

(30) Foreign Application Priority Data
Jul. 19, 2000 (JP) 2000-219118

(51) Int. Cl. G06F 17/00

(52) U.S. Cl. 707/527

(57) ABSTRACT

A memory card 101 stores link information (link file, media file) for use by an image processing apparatus obtaining and printing plural pieces of image data stored in a storage medium or a communication medium different from the memory card as a single first medium so that the image processing apparatus can collectively execute instructions to print both image data stored in the first medium and image data obtained from a second medium according to a print order file stored in the first medium.

### BACKGROUND OF THE INVENTION

1. Field of the Invention

The present invention relates to an information processing apparatus, an image processing apparatus, a print order processing method of the information processing apparatus, and a print request processing method of the image processing apparatus capable of communicating with an image processing apparatus which can perform a printing process according to print control information for control of plural pieces of image data stored in a first medium storing a print order file, and for control of a method of printing the image data.

2. Related Background Art

Upon receipt of an order of printing a photo film which has been used with a conventional silver halide type camera device, the film is normally to be all printed or some target frames in the developed negative or positive film are specified and printed.

On the other hand, a digital camera has been strikingly popularized. As a result, not only films are printed at home, but also a print request service has been more and more spread with recording media taken to a print service shop, and arbitrary image data and the number of copies optionally specified.

As a print ordering method to attain the above mentioned purposes, a system of ordering a print service has been suggested by providing in a removable image medium such as a memory card, etc. a print order file, for example, a DPOF (digital print order format) file, having plural pieces of image data and information used in ordering a print service.

The DPOF system is expected to be mounted and popularly used in a digital camera, a DVC camera, etc. together with an increasing number of corresponding service shops.

However, the digital technology has made remarkable progress recently, and the variety of recording media storing digital data is outstandingly large.

In addition, each manufacturer has developed various media (DVC tape, digital 8 tape, MD, FD, CD-ROM, CD-R, CD-RW, MO, DVD-ROM, DVD-RAM, etc.) such as writable CD-R/RW disks, magnetic tape media for digital recording, as well as various types of memory cards.

Furthermore, it is clear that new media and recording formats are to be developed and put to practical use. With such various media, a large fault is predicted in the above mentioned DPOF system.

That is, there will be a problem with the equipment of a print shop for processing various media from users, and with the method of appropriately processing image print orders of reproduction-only media.

Especially, when a print order is issued for an image in a CD-ROM distributed in a mass market, etc. a DPOF file cannot be written to the same media using a non-writable CD-ROM.

Furthermore, in processing newly developed media, it is a laborious operation to add a new standard to apply the sequential DPOF standard to new media. Additionally, there is the problem of the consistency with the previous DPOF files.

In addition, media drive control information and the information for a reproduction signal process may be required in the DPOF file to reproduce image data from new media.

It is also expected that commercially distributed image information is to be printed, and a corresponding copy management system, etc. may importantly functions. The current DPOF system is based on the user copying an image to his or her own medium and taking it to a print order shop, thereby possibly causing the problem of an increasing number of illegal copies, etc.

Furthermore, with the remarkable spread of Internet, digital contents in a network can be accessed from anywhere to download desired image data, and the method of copying and taking a large volume of high precision image is inconvenient.

### SUMMARY OF THE INVENTION

The present invention aims at solving all or at least one of the above mentioned problems.

The present invention also aims at appropriately processing various media, especially reproduction-only media, and an image print order using a logically rewritable recording medium.

Furthermore, the present invention aims at providing a print ordering method free of taking image data itself to a print shop.

To attain the above mentioned objects, an information processing apparatus capable of communicating with an image processing apparatus which can perform a printing process according to plural pieces of image data stored in a first medium and print control information for control of a method of printing the image data includes: generation means for generating the print control information; and recording means for recording, in the first medium, link information for use by the image processing apparatus in obtaining and printing image data stored in a second medium different from the first medium.

Additionally, the present invention aims at providing a print ordering method more suitable for a print order through a network such as Internet, etc.

To attain the above mentioned purposes, an image processing apparatus capable of performing a printing process according to plural pieces of image data stored in a first medium storing print control information, and print control information for control of a method of printing the image data includes: image data obtaining means for analyzing the print control information transferred from the information processing apparatus through a network, and obtaining image data uploaded into a predetermined server from the information processing apparatus; and print control means for printing the image data obtained by the image data obtaining means according to the print control information.

Further objects and features of the present invention will be clearly described below by referring to the following embodiments of the present invention and the attached drawings.

### BRIEF DESCRIPTION OF THE DRAWINGS

FIG. 1 is a block diagram of a media configuration of a print ordering system to which the image processing apparatus according to the first embodiment of the present invention is applicable;

FIG. 2 shows the internal data structure of the DPOF file, and the contents of the data in an image file and a link file;

FIG. 3 shows the DPOF media process state in the image processing system to which the image processing apparatus according to the present invention is applicable;

FIG. 4 is a flowchart of an example of the first data processing procedure in the image processing apparatus according to the present invention;

FIG. 5 is a flowchart of an example of the second data processing procedure in the image processing apparatus according to the present invention;

FIG. 6 is a diagram shows the DPOF medium process state in the image processing system to which the image processing apparatus according to the second embodiment of the present invention can be applicable;

FIG. 7 is a block diagram of the configuration of the image processing apparatus according to the present invention; and

FIG. 8 shows a memory map of a storage medium storing various data processing program readable in an image processing system to which the image processing apparatus according to the present invention can be applicable.

### DETAILED DESCRIPTION OF THE PREFERRED EMBODIMENTS

(First Embodiment)

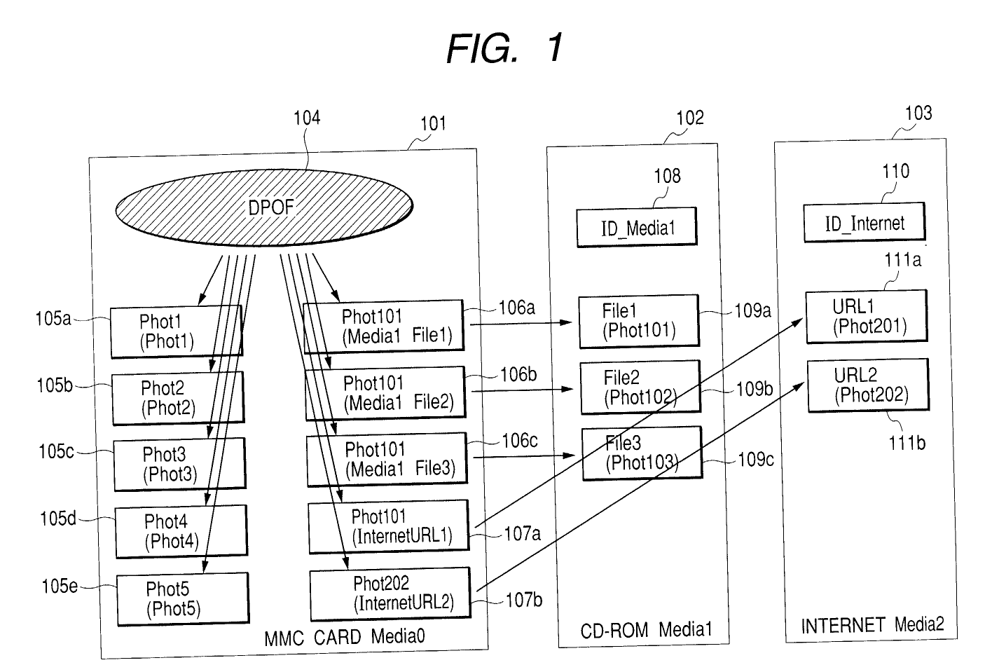

FIG. 1 is a block diagram of a media configuration of a print ordering system to which the image processing apparatus according to the first embodiment of the present invention is applicable, which corresponds to an example of a system of placing a print order of the image data stored in a medium other than the medium storing the DPOF file.

In FIG. 1, reference numeral 101 denotes a multimedia memory card (MMC card). Reference numeral 102 denotes a CD-ROM disk. Reference numeral 103 denotes data recorded in any media in a network such as Internet, a LAN (local area network), etc. Reference numeral 104 denotes a DPOF file. Reference numerals 105a to 105e denote still image files. Reference numerals 106a to 106c denote image data link files for designation of the image files in the CD-ROM disk 102.

Reference numerals 107a and 107b also denote image data link files for designation of the image files accessible in the Internet 103. Reference numeral 108 denotes ID information about the CD-ROM disk 102. Reference numerals 109a to 109c denote still image data files. Reference numeral 110 denotes ID information for designation of an address, etc. in Internet, and designates, for example, a server. Reference numerals 111a and 111b denote image files held in a server accessible through Internet.

In the print ordering system with the above mentioned configuration, when a DPOF file indicates image data in another medium, the DPOF file 104 contains not only the designation information about the image files 105a to 105e in the same medium, but also the information designating an indirectly designated file (hereinafter referred to as a link file) having the information designating the image files 106a to 106c, 107a, and 107b in another medium.

Thus, it is possible to designate the print order of the image data file held in another media (the CDROM disk 102 as the medium 1, and Internet as the medium 2) from the DPOF file 104 through a link file. As a result, it is possible to issue a print order of images in a plurality of media using one DPOF file.

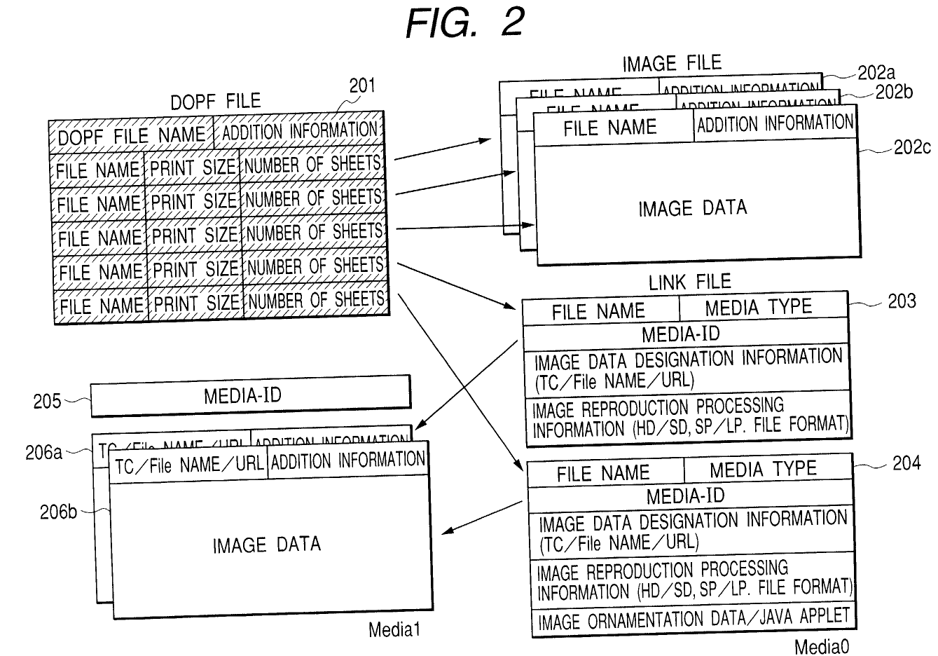

FIG. 2 shows the internal data structure of the DPOF file 104 and the contents of data of an image file and a link file shown in FIG. 1.

In FIG. 2, reference numeral 201 denotes the data structure of a DPOF file, and the data contains a DPOF file name, additional information about the DPOF file, an image file name designating an image to be printed, and the print size and the number of pieces of each image.

Reference numerals 202a to 202c denote the data structure of image files, and the data contains a file name and additional information. Reference numerals 203 and 204 denote the data structure of link files, and the data contains a file name, a media type, a media ID, image data designation information, image reproduction processing information, etc. The link file 204 is an example of a link file when the additional information for use in a process of reproducing an image, etc. is included, that is, when image ornamentation data is included.

The image ornamentation data designates an image reproducing method, and a color amending method, etc. is designated.

Reference numeral 205 denotes ID information about the medium corresponding to the medium ID 108 shown in FIG. 1. Reference numerals 206a and 206b denote the data structure of the image data file in a medium, and the data includes a TC/File name/URL and additional information. By referring to FIG. 2, the data structures of a DPOF file, a link file, and an image file are described below.

The DPOF file name 201 contains a list of file names of images to be printed, print sizes, and numbers of pieces. A name of a link file can be described in the same way as the file name of an image to be printed listed.

If there is a still image in the image file designated by a file name, it is printed as is. However, if it is a link file, the ID information for specifying a medium designated by the contents data of the link file is read, and a request to read image data is issued.

Practically, in a print service shop (digital cafe), a requested medium is reproduced, and the file name of the image data file in the link file is retrieved and displayed. Then, the print data of the image data file read to the printer not shown in the attached drawings is transferred to the printer, and the printing process is performed.

If the media information in the request indicates Internet, the shop accesses Internet from the information processing apparatus (including a personal computer, etc.) accessible through Internet not shown in the attached drawings, downloads the image data on the WWW site according to the URL (uniform resource locator) information (information designating the client of the image data through a communications line) in the link file, and prints the data on the printer not shown in the attached drawings.

Furthermore, if the image ornamentation data is added like the link file 204, a necessary image process is performed depending on the ornamentation data by the information processing apparatus on the indirectly designated image data, and then the processed print data is transferred to and printed on the printer not shown in the attached drawings. For example, when the designation to generate a calendar is recorded as an ornamentation process, it is also possible to print a calendar with photos, etc. by combining an image with text data not shown in the attached drawings.

As another embodiment of an ornamentation process, it is also possible to support various image processes such as an image synthesizing process, a color inverting process, a color amending process, an image rotation process, a mirror process for performing a right-to-left inverting process, an image gray scale reducing process, an edge emphasizing process, etc.

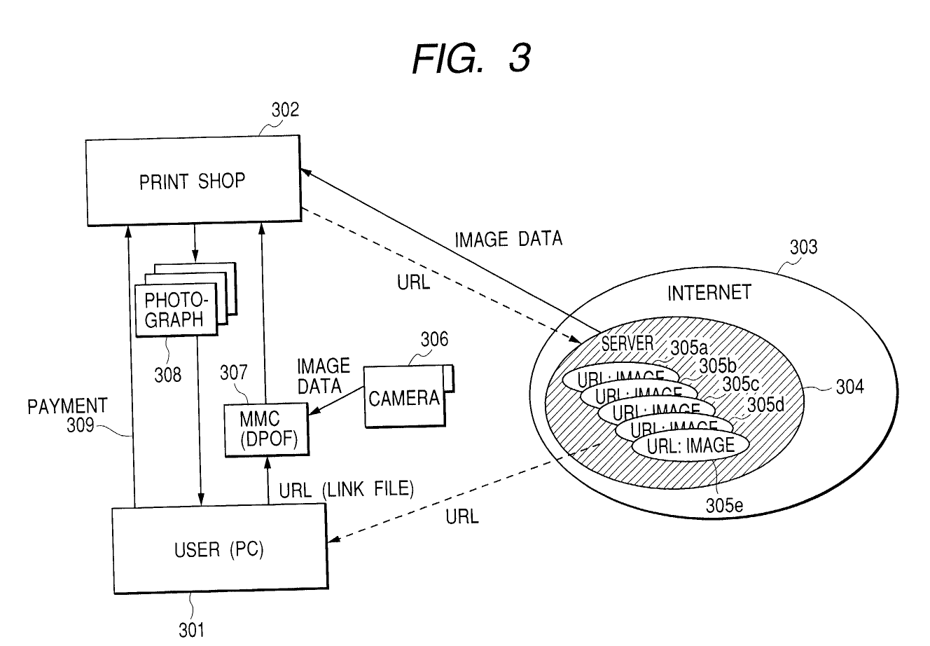

FIG. 3 shows the DPOF medium processing state in the image processing system to which the image processing apparatus according to the present invention can be applied. For example, it shows the communications between a user and a shop for the print ordering method of ordering printing of image information on the Internet.

In FIG. 3, reference numeral 301 denotes a personal computer (PC) of a user who places an order to print data. Reference numeral 302 denotes a print shop, which comprises a device capable of read a DPOF medium, an information processing apparatus, and a printer capable of performing a color printing process, etc.

Reference numeral 303 denotes Internet which can be accessed by the personal computer 301 of a user or the information processing apparatus of the print shop 302. Reference numeral 304 denotes a directory of a server holding image data to be printed, and plural pieces of image data 305a to 305e which can be distributed after being registered for printing or processed in an accounting process are managed for update in the directory.

Reference numeral 306 denotes a digital camera, and the image data of a subject captured by a user is recorded in an MMC card 307 in a predetermined format. Reference numeral 308 denotes a photograph printed on the printer of the print shop 302 according to the designation of the DPOF. Reference numeral 309 denotes a payment for printing from the user to the print shop 302 based on the print request from the user.

In the image processing system with the above mentioned configuration, the image data designated in a print order can be the image data captured by the user using the digital camera 306 and the image data (digital contents) on the Internet Web site provided by a provider.

The digital camera 306 is used with the MMC card 307, and captured image data and a DPOF file are recorded in the MMC. Furthermore, the DPOF data is edited in the user PC 301, a link file holding the URL information indicating the image data on Internet 303 is generated, and the designation of the link file is added in the DPOF file. When the thus processed MMC card 307 is taken to the shop, using the DPOF file read from the MMC card 307, the image data downloaded from any server device on Internet connected according to the image data in the digital camera 306 and the URL recorded in the DPOF file by the information processing apparatus of the print shop 302 is printed, and the user can receive the print result.

In the above mentioned method, a print order can be realized in a very wide range of application, and the method has replaced the conventional system capable of only designating printing from a medium containing image data together with a DPOF file.

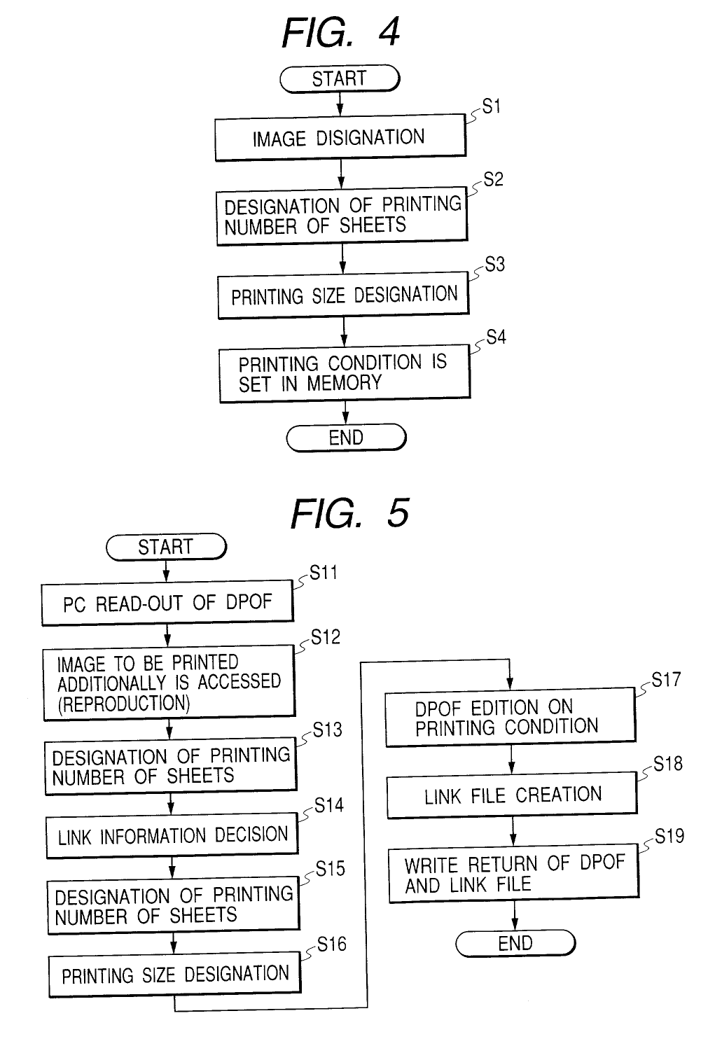

FIG. 4 is a flowchart of an example of the first data processing procedure according to the image processing apparatus of the present invention, and corresponds to the input sequence of generating a DPOF file by the digital camera 306, and designating printing of the image of the camera. (1) to (4) indicates the steps of the process.

First, the recorded image data is retrieved with the monitor (liquid crystal display) of the digital camera 306 not shown in the attached drawings, and the image data to be printed in the print shop 302 is designated by operating the operation key not shown in the attached drawings (1). Then, the number of pieces and the print size of the designated image data are designated by operating the operation key not shown in the attached drawings (2), (3).

Finally, in step (4), a printing condition is set by operating an operation key not shown in the attached drawings, and a rewriting process is set in the MMC card 307, thereby terminating the process.

FIG. 5 is a flowchart of an example of the second data processing procedure in the image processing apparatus according to the present invention, and corresponds to the DPOF file editing procedure for printing an Internet image. (11) to (19) indicate the steps of the process.

First, the user reads a DPOF file from the MMC card 307 (11), the image data to be additionally printed is accessed and reproduced, and the data is displayed, for example, in the thumbnail data format on the display device (not shown in the attached drawings) of the PC 301 (12).

Then, the number of pieces of the image data to be printed in the print shop 302 is designated from among plural pieces of thumbnail-displayed image data (13). Then, the link information is determined by inputting, in addition to the image data, for example, the URL for downloading and printing out the image data on Internet (14).

Then, the number of pieces and print size for the image data recorded in the MMC card 307 and the image data to be obtained according to the link information are designated (15), (16). Then an editing operation is performed to add a link file containing URL information and the file designation designating the link file to a DPOF file (17).

Next, a link file is generated in the file format shown in FIG. 2 (18), and the link file and the DPOF file are rewritten to the MMC card 307 (19), thereby terminating the process.

As described above, images other than the images recorded in the memory card can be designated for printing together. Then, the images not stored in the user PC and the digital camera can be obtained from the server on Internet, the computer in the print shop, etc. to obtain printed photographs, and a photograph can be obtained by synthesizing data with an image not at hand.

It is not necessary for a user to store a large volume of image data, and a print shop can provide a new value added for a user by supplying to the user an image designated by link information.

Furthermore, the CD-ROM disk 102 is used as a link destination above, but a link destination is not limited thereto, and a link can be made to a physically non-rewritable storage medium such as DVD-ROM, etc., or a link can be made to a storage medium not freely rewritable using a password, etc.

Thus, a print order can be issued using an image recorded in a storage medium in which a user cannot directly record print setting information.

(Second Embodiment)

In the above mentioned first embodiment, a DPOF file is taken to a shop using the MMC card 307 as shown in FIG. 3. However, it may be provided that a user can issue a print order to the print shop 302 through Internet. This embodiment will be described below.

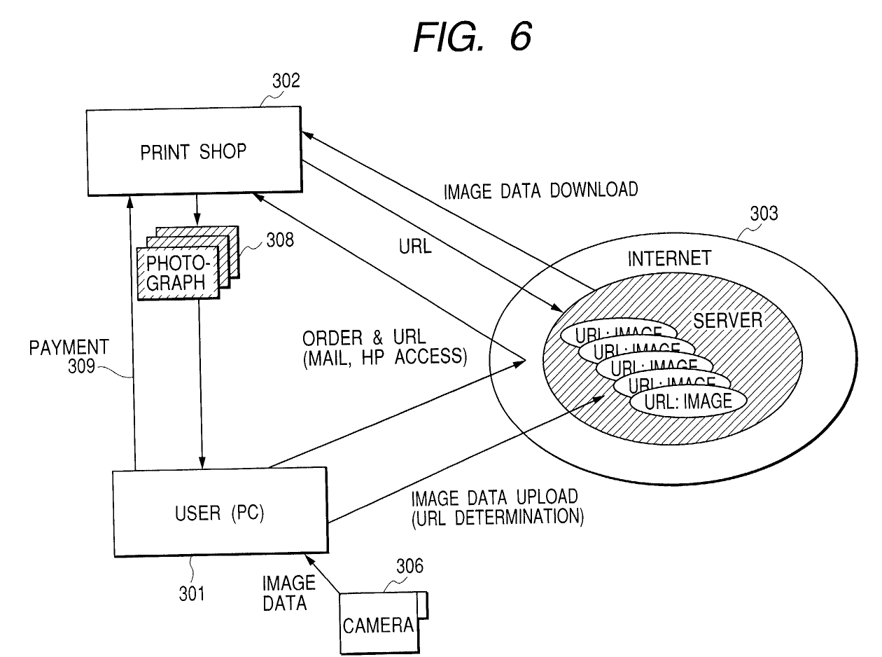

FIG. 6 shows the DPOF media processing state in the image processing system to which the image processing apparatus according to the second embodiment of the present invention can be applied. For example, unlike the system of taking a DPOF file to a shop, a DPOF file or link information is transmitted to a shop through the Internet 303. The units also appearing in FIG. 3 are assigned the same reference numerals.

First, the DPOF file or the information contained in the DPOF is transmitted to the print shop 302 through electronic mail or by filling a print order form on a predetermined home page opened by the print shop 302 in a network, or uploading a print order file of the print shop 302 to the server.

The image data of the digital camera 306 captured by the user is uploaded into the user writable directory in the server on Internet 303, and the link information accessible from the print shop 302 is transmitted to the print shop 302 as the information about the DPOF file.

When the print shop 302 detects the upload in the electronic mail or the print order file and accepts the print order, it downloads and prints the image data designated by the user on the Internet 303 according to the print order information. The completed printout (photograph) is transmitted through electronic mail or a home delivery service to the user.

In this case, the payment 309 is made using a credit card or an electronic accounting system. With the above mentioned configuration of the system, a print ordering system in which a user does not have to go to the print shop 302 can be realized.

If the print shop 302 transmits the contents of the order and a message about fee information to the requester in the method using electronic mail, etc. depending on the contents of a received print order, and an actual printing process is entered upon receipt of an answer to the electronic mail from the requester, then a communications method with the requester can be reserved, and the fee and the request contents can be reconfirmed. As a result, wrong contents or fee trouble can be reduced.

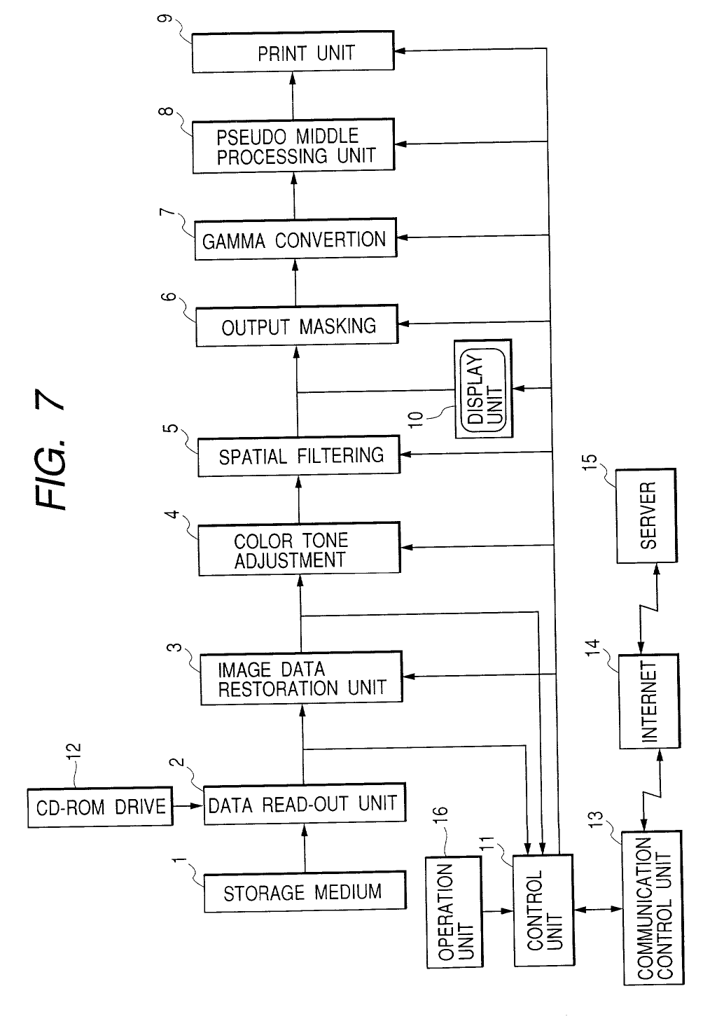

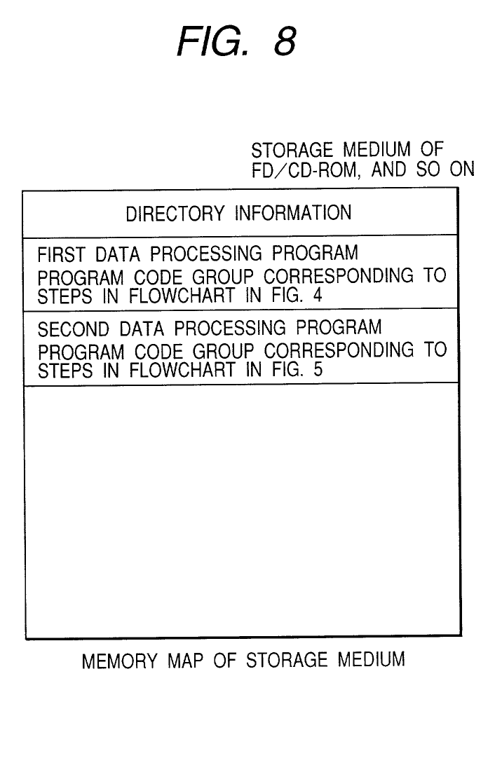

FIG. 7 is a block diagram of the configuration of the image processing apparatus according to the present invention, and corresponds to the configuration on the print shop 302 side shown in FIG. 3, etc. The units also shown in FIG. 3 are assigned the same reference numerals.

In FIG. 7, reference numeral 1 denotes a storage medium attachable to and detachable from the device. The storage medium can be a medium for digital record such as semiconductor memory, a hard disk, an optical disk, etc. The storage medium 1 corresponds to the MMC card 307 shown in FIG. 3, stores the DPOF file shown in FIG. 1 in which files in different media, for example, the image data link files 106a to 106c for designation of an image file in the CD-ROM disk 102, and the image data link files 107a and 107b for designation of an image file accessible through other media, for example, Internet 103 are stored.

Reference numeral 2 denotes a data read-out unit for reading stored data from the storage medium 1. An output data signal is connected to a image data restoration unit 3 and a control unit 11 for controlling the entire system described later.

The signal output from the image data restoration unit 3 is input into a color tone adjustment unit 4. The output of the color tone adjustment unit 4 is input into a spatial filtering 5. The output of the spatial filtering 5 is output to an output masking 6 and a display unit 10. An output signal of the output masking 6 is input into a gamma conversion 7, and an output signal of the gamma conversion 7 is input into a pseudo middle processing unit 8. An output signal of the pseudo middle processing unit 8 is input into a print unit 9, and the print unit 9 generates printout according to an input signal, and the result is output.

Reference numeral 12 denotes a CD-ROM drive which can read image data, etc. stored in a CD not shown in the attached drawings. Reference numeral 13 denotes a communication control unit for downloading desired image data from a server 15 which can distribute digital contents, etc. through Internet 14 according to the URL input from an operation unit 16 or the link information (including a link file with a URL designated) stored in the storage medium 1.

In the print shop 302 with the above mentioned configuration, the storage medium 1 stores an image data file fetched by a digital camera, a video camera, or a scanner, or an image data file generated by a personal computer, and a control information file containing control information.

The control information data file not only can be generated or updated relating to image data when the above mentioned image data file is stored in a storage medium, but also can be edited by adding, changing, deleting data, etc. with the personal computer capable of writing data to the storage medium 1, the digital camera, the video camera, and the scanner.

According to the above mentioned embodiment, it is possible to designate printing an image stored in a DPOF file in different media, and an order to print a plurality of images stored in reproduction-only media and a plurality of media can be issued using one DPOF file. Furthermore, it is also possible to issue a print order of image data stored in a server, etc. accessible through Internet. Furthermore, a business system in which a request to print an image can be issued using a network such as Internet, etc. without taking a medium to a print shop can also be realized.

Furthermore, when an order to print an image in a new medium is issued, the system can be extended without largely reducing the compatibility with the conventional DPOF system.

To prevent an image uploaded into a server by a user from being illegally used by others, it is desired to limit access by encrypting the image stored in the server, using a password, etc.

In this case, key information for decrypting the encryption and password information are to be transmitted to a print shop when a print request is issued so that only the print shot accepting the request can access the stored image.

Thus, the privacy can be guaranteed.

Described below by referring to the memory map shown in FIG. 8 is the configuration of the data processing program readable by an image processing system to which the image processing apparatus according to the present invention can be applied.

FIG. 8 is a diagram showing a memory map of a storage medium storing various data processing program readable by an image processing system to which the image processing apparatus according to the present invention can be applied.

Although not shown in the attached drawings, the information for management of a program group stored in a storage medium, for example, version information, the information storing an author of a program, and depending on the OS, etc. on the program reading side, for example, an icon, etc. for identification and display of a program can also be stored.

Furthermore, the data belonging to various programs is also managed in the above mentioned directory. In addition, if a program for installing various programs in a computer and a program to be installed are compressed, then an unpacking program, etc. can also be stored.

The functions according to the present embodiment shown in FIGS. 4 and 5 can be performed by a host computer through an externally installed program. In this case, the present invention is also applicable when an information group including a program is provided for an output device by a storage medium such as CD-ROM, flash memory, an FD, etc., or from an external storage medium through a network.

As described above, it is obvious that the object of the present invention can be attained by providing a storage medium storing a program code of software realizing the functions of the above mentioned embodiment for the system or the device, and by the computer (or the CPU or the MPU) of the system or the device reading and executing the program code stored in the storage medium.

In this case, the program code read from the storage medium realizes a new function of the present invention, and the storage medium storing the program code constitutes the present invention.

The storage medium for providing a program code can be, for example, a floppy disk, a hard disk, an optical disk, a magneto-optical disk, a CD-ROM, a CD-R, a magnetic tape, a non-volatile memory card, a ROM, a EEPROM, etc.

In addition, by executing a program code read by a computer, the function of the above mentioned embodiment can be realized, the OS (operating system), etc. operating in the computer performs a part or all of the actual processes at an instruction of the program code, and the functions of the above mentioned embodiment can be realized by performing the processes.

Furthermore, after writing the program code read from the storage medium to the memory in the function extending unit connected to a function extending board inserted into the computer or a function extending unit connected to the computer, the CPU, etc. provided in the function extending board or the function extending unit performs a part or all of the actual processes at an instruction of the program code, and the functions of the above mentioned embodiment can be realized by performing the processes.

In the above mentioned embodiment, the method of generating a link file for indirect designation of an image file independent of a DPOF file has been described. The information about a link file may also be included directly in the DPOF file. In this method, the structure of a file becomes complicated, but the effect can be maintained, and the method can be considered to be included in the present invention.

As described above, according to the first to 38th aspects of the present invention, in an information processing apparatus capable of communicating with an image processing apparatus which can perform a printing process according to plural pieces of image data stored in a first medium storing a print order file, and print control information for control of a method of printing the image data, link information for use by the image processing apparatus obtaining and printing the image data stored in a second medium different from the first medium is stored in the first medium. Therefore, instructions can be collectively issued to the image processing apparatus to allow the image processing apparatus to access the second medium other than the first medium according to the stored link information and obtain the image data, and to allow the image data stored in the first medium and the image data obtained from the second medium to be printed according to the print order file.

Furthermore, in an image processing apparatus which can perform a printing process according to plural pieces of image data stored in a first medium storing a print order file, and print control information for control of a method of printing the image data, the link information stored in the first medium is analyzed, the image data stored in the second medium different from the first medium is obtained, and the obtained image data and the image data stored in the first medium are printed according to the link information. Therefore, with the simple configuration of setting in the first medium the link information for access to the second medium, the request to print the image data stored in the first medium and the request to print the image data obtained from the second medium can be simultaneously processed.

Additionally, a print order can be issued without taking a medium storing image data to a digital shop equipped with an image processing apparatus.

The present invention is not limited to the above mentioned embodiments, but many other variations can be designed in the scope of the gist described in the claims of the present invention.

What is claimed is:

1. An information processing apparatus capable of communicating with an image processing apparatus which can perform a printing process according to plural pieces of image data stored in a first medium and print control information for control of a method of printing the image data, comprising:
generation means for generating the print control information; and
recording means for storing, in the first medium, link information for use by the image processing apparatus obtaining and printing the image data stored in a second medium different from the first medium.

2. The apparatus according to claim 1, further comprising:
upload means for uploading the image data recorded in the first medium into a predetermined server device connectable by the image processing apparatus through Internet; and
transfer means for transferring a print order file containing the link information recorded by said recording means in the first medium to the image processing apparatus.

3. The apparatus according to claim 3, wherein said link information contains access information designating the predetermined server device.

4. An image processing apparatus capable of performing a printing process according to plural pieces of image data stored in a first medium recording print control information, and print control information for control of a method of printing the image data, comprising:
obtaining means for analyzing link information stored in the first medium, and obtaining image data stored in a second medium different from the first medium; and
print control means for printing the image data stored in the first medium, and the image data obtained by said obtaining means according to the print control information.

5. The apparatus according to claim 4, wherein said second medium is a non-rewritable recording medium.

6. The apparatus according to claim 4, wherein said link information designates a client of image data through a communications line.

7. The apparatus according to claim 4, wherein said communications line is an Internet network accessible according to the link information.

8. The apparatus according to claim 6, wherein said link information is URL.

9. The apparatus according to claim 4, wherein said link information contains information designating the second medium or information indicating image data in the second medium.

10. The apparatus according to claim 4, wherein said link information contains media control information for reproduction of image data, information indicating a method of reproducing image data reproduced from the second medium, or information allowing access to the image data.

11. The apparatus according to claim 4, wherein said print control information contains sample image data in addition to link information about image data.

12. The apparatus according to claim 4, wherein said link information contains script instruction or program information designating a predetermined operation procedure of performing a process during or after the reproduction of image data from the second medium.

13. The apparatus according to claim 4, wherein said link information contains a name of a network or ID information, a file name specifying image data to be printed in the network, address information, or link information.

14. An image processing apparatus capable of performing a printing process according to plural pieces of image data stored in a first medium recording print control information, and print control information for control of a method of printing the image data, comprising:
image data obtaining means for analyzing the print control information transferred from a information processing apparatus through a network, and obtaining image data uploaded by said information processing apparatus into a predetermined server device; and
print control means for printing the image data obtained by said image data obtaining means according to the print control information.

15. The apparatus according to claim 14, wherein said link information contains URL of a home page.

16. The apparatus according to claim 14, further comprising order reception means for receiving the print control information by electronic mail or detecting input into a print order form on a predetermined home page, and accepting a print request.

17. A print order processing method of an information processing apparatus capable of communicating with an image processing apparatus which can perform a printing process according to plural pieces of image data stored in a first medium recording print control information, and the print control information for control of a method of printing the image data, comprising:
a selecting step of selecting an image to be printed from the image data recorded in the first medium;
a generating step of generating the print control information based on the selection in said selecting step; and
a recording step of recording, in the first medium, link information for use by said image processing apparatus obtaining and printing image data stored in a second medium different from the first medium.

18. The method according to claim 17, further comprising:
an uploading step of said image processing apparatus uploading the image data recorded in the first medium into a predetermined server device connectable through Internet; and
a transferring step of transferring print control information containing link information for download of the image data stored in the second medium to said image processing apparatus.

19. The method according to claim 17, wherein said link information contains access information for specifying the predetermined server device.

20. A print request processing method of an image processing apparatus which can perform a printing process according to plural pieces of image data stored in a first medium and the print control information for control of a method of printing the image data, comprising:
an obtaining step of analyzing link information stored in the first medium, and obtaining image data stored in a second medium different from the first medium; and
a printing step of printing the image data stored in the first medium and the image data obtained in said obtaining step according to the print control information.

21. The method according to claim 20, wherein said second medium is a non-rewritable recording medium.

22. The method according to claim 20, wherein said link information designates a client of image data through a communications line.

23. The method according to claim 22, wherein said communications line is an Internet network accessible according to the link information.

24. The method according to claim 20, wherein said link information is URL.

25. The method according to claim 20, wherein said link information contains information designating the second medium or information indicating image data in the second medium.

26. The method according to claim 20, wherein said link information contains media control information for reproduction of image data, information used in reproduction signal process of image data reproduced from the second medium, or information for obtaining the image data.

27. The method according to claim 20, wherein said print control information contains sample image data in addition to link information about image data.

28. The method according to claim 20, wherein said link information contains script instruction or program information designating a process performed during or after the reproduction of image data from the second medium.

29. The method according to claim 20, wherein said link information contains a name of a network or ID information, a file name specifying image data to be printed in the network, or address information.

30. A print request processing method of an image processing apparatus capable of performing a printing process according to plural pieces of image data stored in a first medium recording print control information, and print control information for control of a method of printing the image data, comprising:
an image data obtaining step of analyzing the print control information transferred from an information processing apparatus through a network, and obtaining image data uploaded by said information processing apparatus into a predetermined server device; and
a print control step of printing the image data obtained in said image data obtaining step according to the print control information.

31. The method according to claim 30, wherein said link information contains URL of a home page.

32. The method according to claim 30, further comprising
an order receiving step of receiving the print control information by electronic mail or detecting input into a print order form on a predetermined home page, and accepting a print request.

33. The apparatus according to claim 1, wherein said print control information is based on a DPOF file format.

34. The apparatus according to claim 4, wherein said print order file is based on a DPOF file format.

35. The apparatus according to claim 16, further comprising transmission means for transmitting a message of contents of an accepted print order and fee information to a requester depending on the contents of the order.

36. The apparatus according to claim 35, wherein a response to the message transmitted by said transmission means is received from the requester, and a printing process is performed based on the contents of the print order upon receipt of the response.

37. The method according to claim 32, further comprising a transmitting step of transmitting a message of contents of an accepted print order and fee information to a requester depending on the contents of the order.

38. The method according to claim 37, wherein a response to the message transmitted by said transmission means is received from the requester, and a printing process is performed based on the contents of the print order upon receipt of the response.
